(19) United States
(12) Patent Application Publication
(10) Pub. No.: US 2007/0265038 A1
(43) Pub. Date: Nov. 15, 2007

(54) Notification System And The Method Of Mobile Phone Call Arrival Using Sound Communication

(76) Inventor: Joon Sik Kim, Daejeon (KR)

Correspondence Address: SUGHRUE MION, PLLC, 2100 PENNSYLVANIA AVENUE, N.W., SUITE 800, WASHINGTON, DC, 20037, US

(21) Appl. No.: 11/742,851

(22) Filed: May 1, 2007

(30) Foreign Application Priority Data
May 1, 2006 (KR) 10-2006-0039336

(51) Int. Cl. H04B 1/38

(52) U.S. Cl. 455/567

(57) ABSTRACT

Disclosed is an incoming call notifying system for notifying a user of an incoming call of a mobile terminal. The incoming call notifying system comprises: a mobile terminal including a speaker configured to output a sound wave and a controller configured to control so as to output a sound wave signal of a predetermined frequency to the speaker in the incoming call; and an incoming call notifying apparatus including a microphone configured to receive a surrounding sound wave, a processor configured to analyze the sound wave received from the microphone, determine whether the received sound wave is the sound wave signal sent from the speaker of the mobile terminal, and if so, send a command a to notifying means.

### BACKGROUND

1. Field of the Invention

The present invention relates to a system for notifying a user of an incoming call of a mobile terminal such as PDAs, smart phones, and others, and a method using the same, and more particularly, to a system for notifying a user of an incoming call of a mobile terminal using a sound, vibration, light emitting, and others.

2. Description of the Related Art

Recently, with the development of a mobile communication network and a communication network, a mobile terminal, such as potable terminals, PDAs, smart phones, and others, has been come into wide use as personal necessaries. The mobile terminal receives an incoming call sent from a base station or an Access Point (AP) and notifies a user of the incoming call using a sound, vibration, or light emitting.

However, depending on the location or situation where the user is present, there may be the case where generation of a ring tone would bother people in the adjacent area. Because most of users carry the mobile terminal into his/her pocket or bag, the users can not hear the ringing tone. Accordingly, there may be the case where the ringing tone would bother surrounding people for a long time. In addition, there may be the case where the user was momentarily under the illusion that the ringing tone of other people was his/her ringing tone in crowded places.

As such, when the user is located in the crowded places or noise places, when the user carries the mobile terminal in his/her pocket or bag, when a manner mode is set by the user, and when the user is at the constant distance from the mobile terminal, the user can not recognize the incoming call of the mobile terminal. Therefore, there is a problem in that the user can not receive important communication requests or important messages.

To solve the problem, a portable mobile terminal, in which the user can recognize the incoming call, even when he/she is at the constant distance from the mobile terminal, has been developed.

Various incoming call notifying systems are disclosed in Korean Patent Application No. 1997-0703354 titled “incoming call system”.

In the patent application, an incoming call notifying apparatus receives an incoming call signal sent to a portable terminal from a base station and a reply signal sent to the base station from the portable terminal in order to inform a user of the incoming call using a sound, vibration and light emitting. As one example, there are a transmitter connected to a connection terminal such as an earphone terminal of the portable terminal for detecting the incoming call from the connection terminal and transmitting a radio wave to the incoming call notifying apparatus and a small-sized portable incoming call notifying apparatus having ring, watch and accessory shapes so as to receive and decipher the radio wave transmitted from the transmitter and notify the user of the incoming call using the sound, vibration and light emitting. As another example, there is a portable incoming call notifying apparatus that when the portable terminal receives the incoming call signal, a near-field wireless communication apparatus such as a Bluetooth in the portable terminal transmits the radio wave and then the wireless communication apparatus of the incoming call notifying apparatus receives and deciphers the radio wave transmitted from the portable terminal, so as to notify the user of the deciphered radio wave.

Conventionally, in the case where the incoming call notifying apparatus receives and deciphers the incoming call signal or the incoming call reply signal between the base station and the portable terminal, it should include a receiving unit for receiving directly a long-distance communication signal between the base station and the portable terminal. To prevent an error operation and improve security ability by distinguishing the incoming call of the user's portable terminal from the incoming call of surrounding portable terminals, the long-distance communication receiving unit inside the incoming call notifying apparatus should be constituted to be in the proximity of a level of the long-distance communication receiving unit inside the conventional portable terminal, thereby allowing cost, power consumption and size to be increased.

In case of the transmitting unit for detecting the incoming call and transmitting the radio wave in the status that the connection terminal of the portable terminal is connected to, and the portable incoming call notifying apparatus for receiving, deciphering and notifying the radio wave, the user should additionally purchase a separate transmitting unit except the incoming call notifying apparatus, thereby allowing the cost to be increased. In addition, the user should use the portable terminal in the status that the transmitting unit is connected to the portable terminal, thereby allowing the user to feel inconvenient.

In the case where the near-field wireless communication unit such as the Bluetooth system in the portable terminal transmits the radio wave and the wireless communication unit of the incoming call notifying apparatus receives the radio wave transmitted from the portable terminal, there is an disadvantage in that the user should separately purchase the portable terminal with built-in near-field wireless communication unit such as Bluetooth.

Therefore, in order to use the incoming call notifying apparatus, there is a need for a near-field communication technology that can use all potable terminals by downloading software without replacing the user's portable terminal and adding the separate transmitting unit.

### SUMMARY

Accordingly, an object of the present invention is to provide a near-field communication system and method thereof that can effectively provide an incoming call notifying service by purchasing an incoming call apparatus while using an already held mobile terminal without purchasing a separate mobile terminal or a transmitting unit in the mobile terminal.

Another object of the present invention is to provide a near-field communication system and method thereof that can communicate with an incoming call notifying apparatus without purchasing a separate transmitting module or a transmitting unit and affecting performance of a hand-held mobile terminal.

Still another object of the present invention is to provide a near-field communication system and method thereof that can be adapted to various surrounding circumferences so as to perform stably an incoming call notification, even when a user is present in a very calm situation or a very noisy situation.

Still another object of the present invention is to provide an interference prevention and security near-field communication system and method thereof that can secure liability for the transmission of the incoming call notifying signal.

Still another object of the present invention is to provide a low power near-field communication system and method thereof that can minimize power consumption of the incoming call notifying apparatus.

Still another object of the present invention is to provide a system and method of preventing the missing of the mobile terminal by notifying that it is at a constant distance from the incoming call notifying apparatus.

Still another object of the present invention is to provide an incoming call notifying apparatus that can be notified of the case where the user can not presently make calls, when receiving the incoming call.

Additional advantages, objects and features of the invention will be set forth in part in the description which follows and in part will become apparent to those having ordinary skill in the art upon examination of the following or may be learned from practice of the invention.

According to an aspect of the present invention, there is provided an incoming call notifying system for notifying a user of an incoming call of a mobile terminal, which comprises: a mobile terminal including a speaker configured to output a sound wave and a controller configured to control so as to output a sound wave signal of a predetermined frequency to the speaker in the incoming call; and an incoming call notifying apparatus including a microphone configured to receive a surrounding sound wave, a processor configured to analyze the sound wave received from the microphone, determine whether the received sound wave is the sound wave signal sent from the speaker of the mobile terminal, and if so, send a command to a notifying means; wherein the notifying means includes a motor, a display and a speaking unit.

According to another aspect of the present invention, there is provided a method for notifying a user of an incoming call of a mobile terminal using an incoming call notifying apparatus separated from the mobile terminal, which comprises: the mobile terminal receiving the incoming call from a base station; outputting a sound wave signal of a predetermined frequency band through a built-in speaker, when the incoming call is received; the incoming call notifying apparatus receiving the sound wave signal from the mobile terminal among the received sound waves; and notifying a user of the incoming call of the mobile terminal through a notifying means, when the sound wave signal is received.

### BRIEF DESCRIPTION OF THE DRAWINGS

The above and other objects, features and advantages of the present invention will be more apparent from the following detailed description taken in conjunction with the accompanying drawing, in which:

FIG. 1 is a diagram illustrating constituents of a conventional incoming call notifying system including an incoming call notifying apparatus for receiving an incoming call signal or an incoming call reply signal between a base station and a mobile terminal;

FIG. 2 is a diagram illustrating constituents of a conventional incoming call notifying system including a sending apparatus for sending a radio wave, when an incoming call is detected in a state that a connection terminal of the mobile terminal is connected to, and an incoming call notifying apparatus for receiving the radio wave;

FIG. 3 is a diagram illustrating constituents of a conventional incoming call notifying system of sending the incoming call signal from the mobile terminal with built in near-field wireless communication apparatus and receiving the incoming call signal using a wireless communication apparatus of the incoming call notifying apparatus;

FIG. 4 is a diagram illustrating an incoming call notifying system using a near-field-sound communication according to an exemplary embodiment of the present invention;

FIG. 5 is a block diagram illustrating a mobile terminal of the incoming call notifying system according to the exemplary embodiment of the present invention;

FIG. 6 is a block diagram illustrating an incoming call notifying apparatus of the incoming call notifying system according to the exemplary embodiment of the present invention;

FIG. 7 is a flow chart illustrating a method of notifying a user of an incoming call using a color vibration;

FIG. 8 is a flow chart illustrating a method of encoding and decoding data according to coding rules;

FIG. 9 shows a mapping table constituted of a sound wave frequency, amplitude, and phase as characteristic values that are converted according to digital data;

FIG. 10 shows a mapping table constituted of an MFSK (M-ary Frequency Shift Keying) modulation frequency as a characteristic value that is converted according to digital data;

FIG. 11 shows 4 factors that determines the coding rule and establishes a sound wave communication standard;

FIG. 12 is a flow chart illustrating processes for establishing the near-field-sound-wave communication between the mobile terminal and the incoming call notifying apparatus;

FIG. 13 is a diagram illustrating constituents for a menu of the sound wave communication standard;

FIG. 14 is a diagram illustrating an example for a data packet frame of the near-sound-wave communication;

FIG. 15 shows a mapping rule using combination of two frequency sounds and a method of applying a disallowable frequency sound and a meaningless frequency sound, where the disallowable frequency sound is E2 sound and the meaningless frequency sound is F2# sound;

FIG. 16 shows a timing explaining sending/receiving timing synchronization for a low power sound wave communication; and

FIG. 17 is a flow chart illustrating a method of notifying the user of the mobile terminal's separation and preventing the mobile terminal from being lost.

### DETAILED DESCRIPTION OF EXEMPLARY EMBODIMENTS

Hereinafter, preferred embodiments of the present invention will be described in detail with reference to the accompanying drawing. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

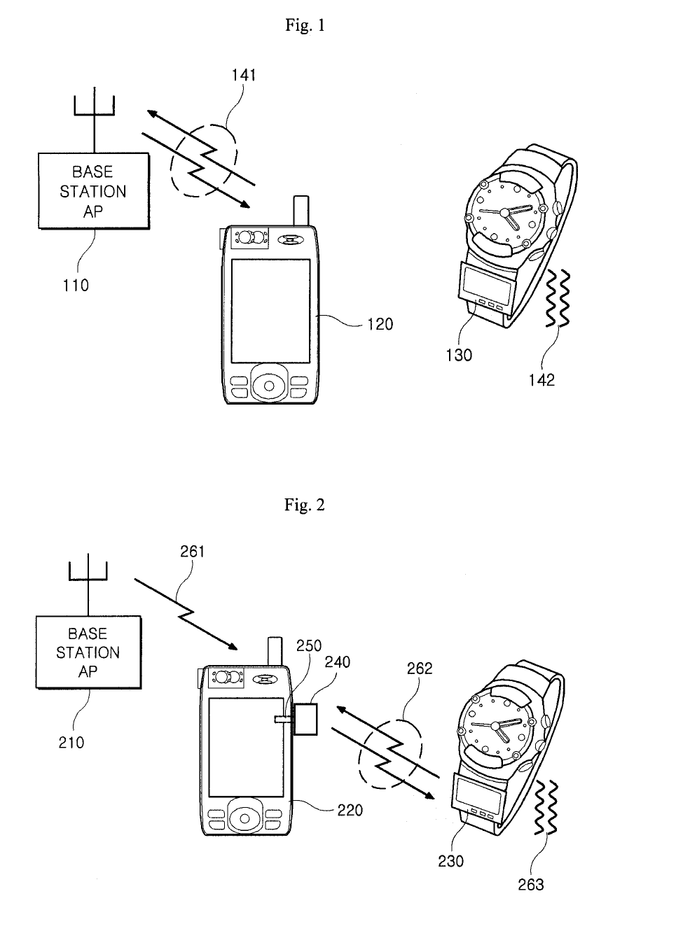

FIG. 1 is a diagram illustrating constituents of a conventional incoming call notifying system including an incoming call notifying apparatus for receiving an incoming call signal or an incoming call reply signal between a base station and a mobile terminal.

If call requests, text messages and voice/image messages are received from an outgoing call-side mobile terminal in a long-distance communication network such as a mobile communication network, the base station or an Access Point (AP) adjacent to a incoming call-side mobile terminal 120 sends an incoming call signal 141 including the messages or the call request for the incoming side mobile terminal according to a communication protocol. The incoming call notifying apparatus 130 has, for example, a ring shape, a watch shape and an accessory shape, or attaches thereon.

The incoming call notifying apparatus receives the incoming call signal 141 being sent from a base station or the AP. When the incoming call notifying apparatus receives the incoming signal, it notifies a user of the incoming call using a sound, vibration or light emitting 142, each which is produced from a speaker, a buzzer, a rotating motor or a light emitting apparatus.

FIG. 2 is a diagram illustrating constituents of a conventional incoming call notifying system including a sending apparatus for sending a radio wave, when an incoming call is detected.

If a call request or a message, etc. is received from an outgoing side terminal, the base station or an Access Point (AP) 210 adjacent to an incoming call-side mobile terminal 220 sends an incoming call signal 261 including the messages or the call request for the incoming side mobile terminal according to a communication protocol. A transmitter 240 transmitting a radio wave by detecting the incoming call can be detachably mounted in a connection terminal 250 of the mobile terminal. The connection terminal 250 may be an earphone-microphone connection terminal attached on the mobile terminal such as a portable terminal. In the state that the transmitter 240 is connected to the mobile terminal, if the mobile terminal receives the incoming call signal 261 including the call request or message from the base station or the AP, the mobile terminal sends an electrical signal informing the incoming call to the transmitter 240. The transmitter detects the incoming call and sends a radio wave 262 informing the incoming call from a near-field wireless communication unit with built-in Bluetooth, ZigBee, and others, to the incoming call notifying apparatus 230 corresponding to the mobile terminal. If the incoming call notifying apparatus receives the incoming call signal, the incoming call notifying apparatus notifies the user of the incoming call using the sound, vibration or light-emitting 263, each of which is produced from the buzzer, the rotation motor or the light-emitting apparatus.

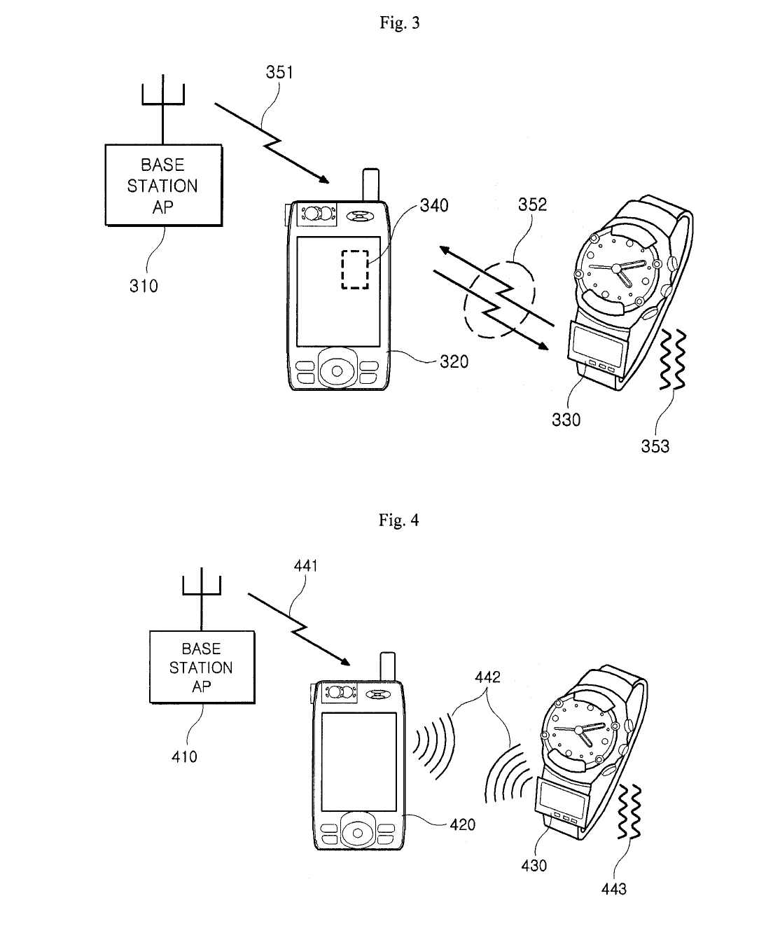

FIG. 3 is a diagram illustrating constituents of a conventional incoming call notifying system of sending the incoming call signal from the mobile terminal with built in near-field wireless communication apparatus and receiving the incoming call signal using a wireless communication apparatus of the incoming call notifying apparatus.

If the call request or message is received from the outgoing side terminal, the base station or an Access Point (AP) 310 adjacent to the incoming call-side mobile terminal 320 sends an incoming call signal 351 including the messages or the call request for the incoming side mobile terminal according to a communication protocol.

The mobile terminal detects the incoming call and sends a radio wave 352 informing the incoming call from a near-field wireless communication unit 340 with built-in Bluetooth, ZigBee, and others, to the incoming call notifying apparatus 330 corresponding to the mobile terminal. If the incoming call notifying apparatus receives the incoming call signal, the incoming call notifying apparatus notifies the user of the incoming call using the sound, vibration or light-emitting 263, each of which is produced from the buzzer, the rotation motor or the light-emitting apparatus.

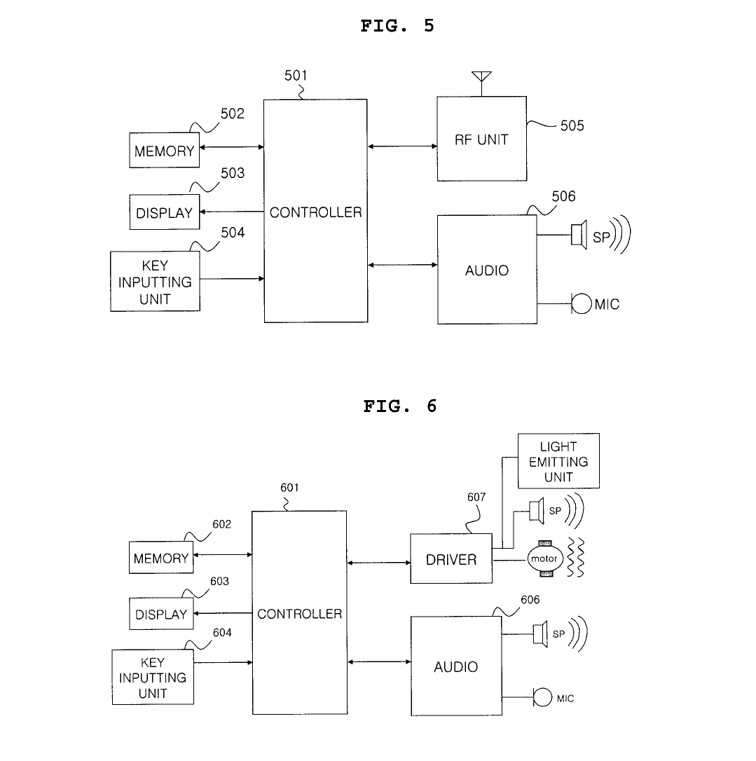

FIG. 4 is a diagram illustrating an incoming call notifying system using a near-field-sound communication according to an exemplary embodiment of the present invention.

If call requests, text messages and voice/image messages are received from an outgoing call-side mobile terminal in a long-distance communication network such as a mobile communication network, the base station or the Access Point (AP) adjacent to a incoming call-side mobile terminal 420 sends an incoming call signal 441 including the messages or the call request for the incoming side mobile terminal according to a communication protocol.

The mobile terminal detects the incoming call, carries incoming call notifying information on a radio wave 442 using the speaker and the audio processor, and sends the radio wave 442 to the incoming call notifying apparatus 430 that corresponds to the mobile terminal. A sound wave communication carries information on the sound wave using a sound wave generating unit such as the speaker and the audio processor and sends the information, and receives the sound wave sent using a sound wave detector, such as the microphone, and the audio processor as a sound wave receiver.

The incoming call notifying apparatus with built-in sound wave receiver has, for example, shapes of a wrist band, a ring, a watch, accessories, or attaches thereon. The incoming call notifying apparatus includes the sound wave receiver and sound wave transmitter. If the incoming call notifying apparatus receives the incoming signal, it notifies a user of the incoming call using a sound, vibration or light emitting 443, each of which is produced from a speaker, a buzzer, a rotating motor or a light emitting apparatus.

FIG. 5 is a block diagram illustrating a mobile terminal of the incoming call notifying system according to the exemplary embodiment of the present invention.

A RF unit 505 is used for a long-distance wireless communication using a general mobile communication. An audio unit 506 performs the sound wave communication. The sound wave communication can perform using the speaker and the microphone. Accordingly, the sound wave communication can be implemented by hardware of the mobile terminal.

FIG. 6 is a block diagram illustrating an incoming call notifying apparatus of the incoming call notifying system according to the exemplary embodiment of the present invention.

In the incoming call notifying apparatus, a power supply is usually applied to the battery. All elements and a power supplier (not shown) of the incoming call notifying apparatus are designed to accomplish low power consumption. The sound wave receiver includes an audio unit 606 and the sound wave detector like the microphone. The sound wave receiver receives the sound wave with the incoming call notifying information sent from the mobile terminal. As one example, the incoming call notifying apparatus includes the sound receiver and the sound wave transmitter. The sound wave transmitter includes a sound wave generating unit such as the audio unit and the speaker.

The sound wave communication communicates using the sound wave with a frequency of above 15 kHz approximately so as to perform a silent communication without being harsh to the ear.

The incoming call notifying apparatus notifies the user of the incoming call using the sound that is produced from the audio unit and the speaker/buzzer, the vibration that is produced from a motor driver 607 and the motor, or the light emitting that is produced from the display 603 or the light emitting apparatus. The display 603 and a key inputting unit 604 are included as one embodiment of the incoming call notifying apparatus. The display 603 notifies the user of the incoming call using an LCD, an EL and an LED.

According to one embodiment of the present invention, there are provided a color vibration system, a color sound system and a color light emitting system that can provide differently the vibration, the sound and the light emitting of the incoming call according to a caller. The color vibration is produced by controlling variably a speed of the motor using the motor driver 607. The strength of the vibration is changed by variably controlling a rotation speed of the motor, and thus the vibration of a desired pattern is obtained by controlling the speed of the motor. This enables the color vibration to be produced. The color sound is produced by the sound wave generating unit such as the audio 606 and the speaker. The color light emitting is produced by a displayed content or the light emitting of the display 603.

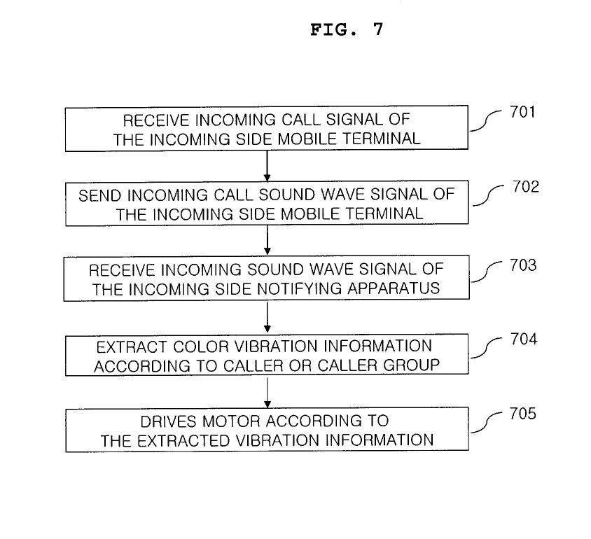

FIG. 7 is a flow chart illustrating a method of notifying a user of an incoming call using a color vibration.

If an incoming side mobile terminal receives an incoming call signal and sends a sound wave with incoming call information, an incoming call notifying apparatus receives an incoming call sound signal S701 to S703. User can set a different type of an incoming call notifying vibration (i.e. color vibration) according to each incoming a caller or a caller group. The color vibration information can be set by matching specific vibration pattern to the specific caller id within telephone list in the mobile terminal. The color vibration information according to the caller is stored in a memory of the incoming call notifying apparatus or a memory of an incoming call mobile terminal. When the incoming call received, a controller 601 of the incoming call notifying apparatus identifies the caller or caller group and instructs the motor driver to control the speed of the motor, according to the color vibration information S704 to S705. A color ring tone and a color light emitting is performed by processes similar to S701 to S705.

The color vibration, the color ringing tone and the color light emitting can produced on the basis of the caller reference as wall as the kinds or contents of the incoming messages. In other words, the vibration, ringing tone and light emitting can respectively be produced according to messages such as SMS or MMS, guide information such as stock price or news, and advertisement messages, differently from the incoming call of the general mobile terminal.

As another embodiment of the present invention, to simplify the structure of the incoming call notifying apparatus, the mobile terminal sends the sound wave signal including notifying pattern preset to the mobile terminal according to caller, caller group or incoming message, and the incoming call notifying apparatus produces the color vibration, the color ringing tone and the color light emitting by enabling a processor to control a notifying means according to the different pattern included in the received sound wave signal from the mobile terminal. In other words, the mobile terminal determines a vibration period of the motor and a light emitting period of the light emitting apparatus so as to send a signal having a desired pattern based on the determination result using the sound wave communication. The incoming call notifying apparatus drives the driver according to the signal pattern. In this case, the vibration pattern or the light emitting pattern used in the incoming call notifying apparatus may be the same as the pattern sent from the mobile terminal. The other hands, the vibration pattern or the light emitting pattern used the incoming call notifying apparatus may be converted from the pattern sent from the mobile terminal through a converting process using a pattern converting table by controller 601.

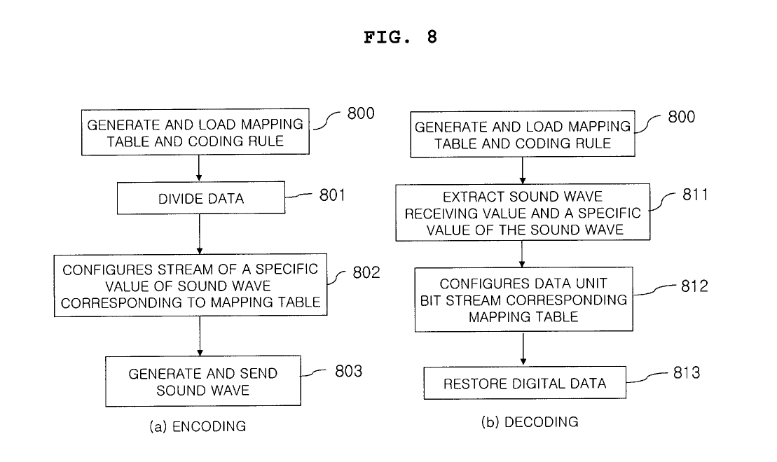

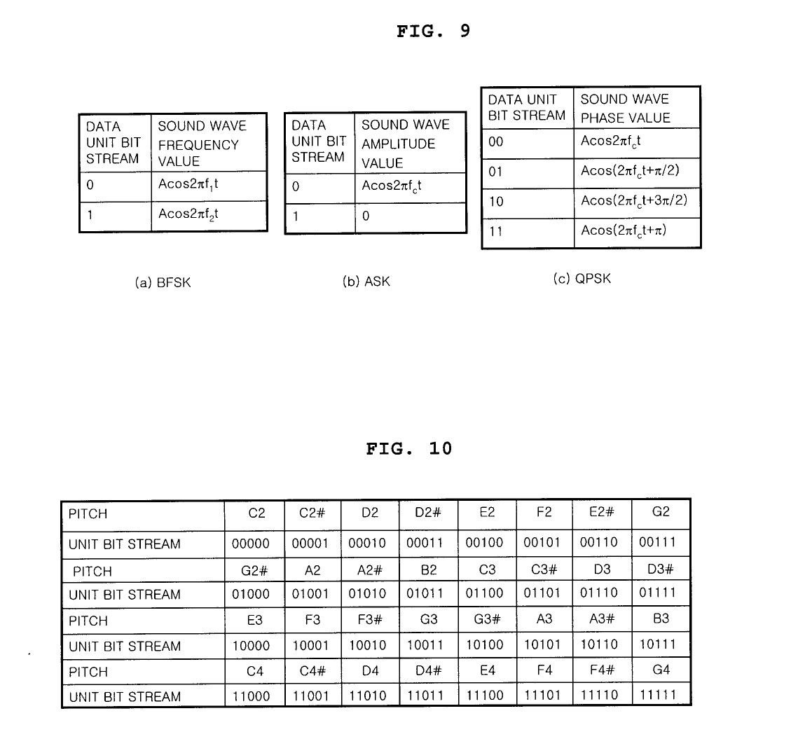

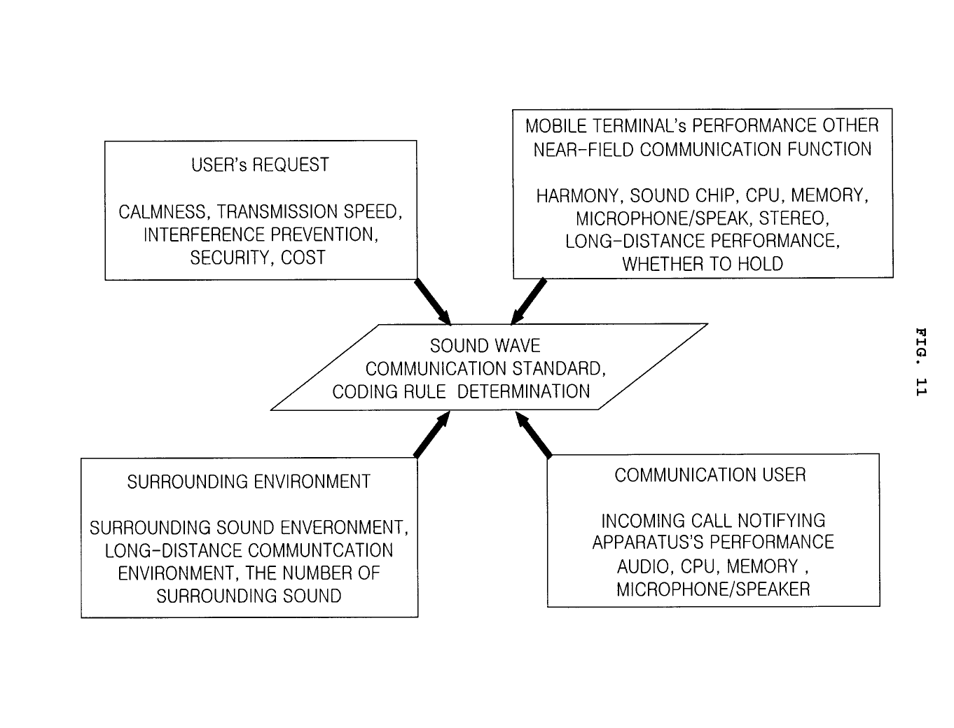

FIG. 8 is a flow chart illustrating a method of encoding and decoding data according to coding rules.

A coding rule means a series of rules that converts an original digital data, encodes the converted digital data to a sound wave so as to send the encoded sound wave, and decodes the received sound wave to restore the original digital data. The coding rule is determined by information for generating and changing a mapping table including various information related to the digital data and sound wave. The coding rule includes the mapping table that the digital data corresponds to specific values (e.g., frequency, amplitude, phase), information for generating and changing the mapping table, an unit time of the sound wave, information on data frame structure, volume level, microphone sensitivity, and others. According to the specific value of the sound wave corresponding to the digital data, the sound wave frequency is a frequency shift keying (FSK) data modulation, the phase is a phase shift keying (PSK) data modulation, and the amplitude is an amplitude shift keying (ASK) data modulation. If the specific value is the combination of the frequency, phase and amplitude, it is a complex modulation such as a quadrature amplitude modulation (QAM). Additionally, the coding rule includes time synchronization for synchronizing a data sending/receiving time between the mobile terminal and the incoming call notifying apparatus, a same tone continuation evasion rule for preventing same tone from being continuously sent, and a coding rule.

FIG. 8a shows an encoding process according to the coding rule, and FIG. 8b shows a decoding process. A sound wave communication system that protects strongly against interference and has high communication security ability is required. Accordingly, the mapping table and coding rule are generated and loaded for the encoding and decoding S800. In the step S800, one or more mapping tables are generated by performing that each specific value of the sound wave corresponds to the digital data according to information for generating and changing a predetermined mapping table. By distinguishing the user's mobile terminal from the other mobile terminal and the incoming call notifying apparatus, a specific mapping table to be used only between the user's mobile terminal and the incoming call notifying apparatus is selected and loaded. If the mapping table and coding rule are generated and loaded in the step S800, an encoding is performed in steps S801 to 803, and a decoding is performed in steps 811 to 813. The encoding according to the coding rule of FIG. 8a includes dividing the digital data to be sent into a set digital data unit S801, converts a bit stream of each digital data unit to a stream of specific values (i.e., frequency, amplitude, phase) that corresponds to the mapping table S802, and generates and sends a composite sound wave having a characteristic value of each sound wave S803. The decoding according to the loaded coding rule of FIG. 8b includes abstracting the characteristic value of the sound wave from the received sound wave S811, converting the abstracted characteristic value of the sound wave to a unit bit stream of the digital data S812, and restoring the data unit bit stream to digital data S813.

FIG. 9 shows a mapping table constituted of a sound wave frequency, amplitude, and phase as characteristic values that are converted according to digital data.

FIG. 9a shows an embodiment of a BFSK modulation in the FSK modulation that the characteristic value is a sound wave frequency. The BFSK modulation converts two frequencies f1 and f2 of the sound wave that correspond to bits (0, 1). FIG. 9b shows an embodiment of an ASK modulation that the characteristic value is a sound wave phase. FIG. 9c shows an embodiment of a quadrature phase shift keying (QFSK) modulation in a PSK modulation that the characteristic value is a sound wave phase, where a phase “0” is converted corresponding to a data unit bit stream “00”, a phase “π/2” is converted corresponding to the data unit bit stream “01”, a phase “3π/2” is converted corresponding to the data unit bit stream “10”, and a phase “π” is converted corresponding to the data unit bit stream “11”.

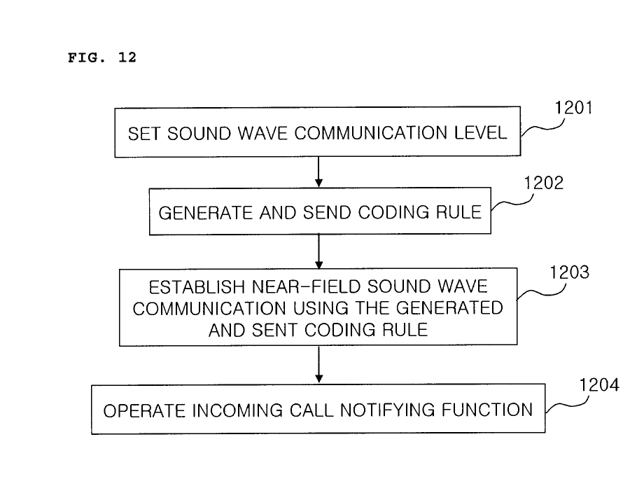

FIG. 10 shows a mapping table constituted of an MFSK (M-ary Frequency Shift Keying) modulation frequency as a characteristic value that is converted according to digital data. It is desirable that a pitch of the music sound is a frequency sound used for the MFSK. FIG. 10 shows an example of a mapping table for converting the digital data into a pitch stream of a short sound. By mapping each musical interval (frequency) of the sound wave and the digital data, it is recognized that the digital data is sent using the sound wave. In another embodiment, there is provided a mapping table that converts the digital data to a stream of combination of two pitches.

However, when the mobile terminal establishes the sound wave communication in various surrounding environment, a communication error can be produced due to disturbance caused by the surrounding noise. Accordingly, there is additionally provided a method of assuring adequateness for the sound wave communication according to the coding rule.

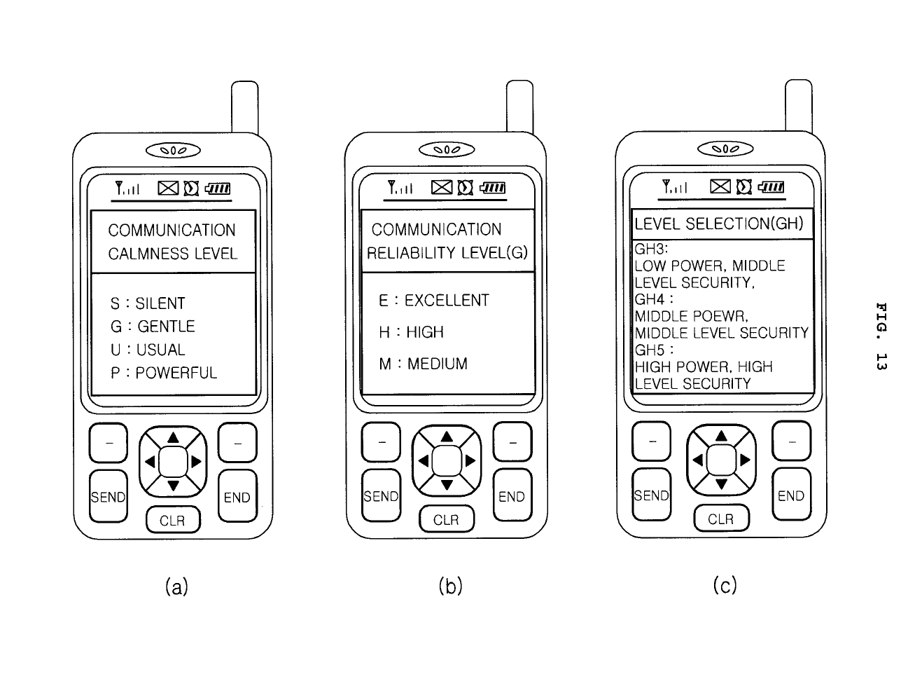

FIG. 11 shows 4 factors that determines the coding rule and establishes a sound wave communication standard.

Referring to FIG. 11, the 4 factors include user's request facts, surrounding environment, mobile terminal's performance and incoming call notifying apparatus's performance. Considering the 4 factors, it is possible to determine a proper coding rule adapting to the surrounding situation and implement an effective sound wave communication.

The user's request facts include calmness, low power, interference prevention, security, communication speed, low cost, and others. The extent of calmness request is affected by the surrounding situation. Even where the surrounding sound is calm, if there are not people, the extent of calmness request is low. If there are many people and too much noise, the extent of calmness request is low. Also, the extent of calmness request is different according to places. The interference prevention request, the security request, and the communication speed request depend on the incoming call notification. A trade-off relationship exists between the request facts. For example, the low power request is limited to the interference prevention request, the security request and the communication speed request.

The surrounding environment includes a surrounding sound environment, the number of surrounding sound wave communication users, a long-distance communication environment. As the mobile terminal is used in various environments, it is important to consider the surrounding environments. The surrounding sound environments include, for example, when the surrounding sound is noisy, when a calumniator causes a disturbance sound wave, when the mobile terminal is placed in calm place, etc. The number of surrounding sound wave communication users means the number of users that use a near field sound wave communication in a short-distance. If the number of the users is increased, it is necessary to consider server sound wave interference. According to one embodiment, the user grasps the surrounding environment by sensing a surrounding micro sound wave and a sound wave of the mobile terminal itself.

The mobile terminal's performance and incoming call notifying apparatus's performance include an audio's performance such as a sound chip, a range of the sound wave frequency, stereo ability, processing/memory ability, whether to have other near-field communication function (e.g., wire, Bluetooth, zigbee, IRDA, etc.), a long-distance communication ability, etc.

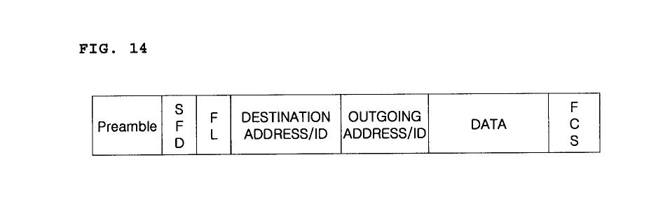

FIG. 12 is a flow chart illustrating processes for establishing a near-field-sound-wave communication between the mobile terminal and the incoming call notifying apparatus.

In a process of establishing the near-field sound wave communication between the mobile terminal and the incoming call notifying apparatus, a sound wave communication system is constructed between the mobile terminal and the incoming call notifying apparatus using an already holding mobile terminal without purchasing and installing a separate mobile terminal. An adaptive sound wave communication system is provided to be adapted to the sound wave communication of various situations and various surrounding sound situations according to performance of the user's mobile terminal and the incoming call notifying apparatus. An interference prevention and security sound wave communication system is provided to assure reliability of the transmission. In order to provide the systems, when the sound wave communication is established, the coding rule and/or sound wave communication standard are sent.

The sound wave communication standard defines the extent of a sending speed, the volume of the sound wave, and the number of chords, in stages, so as to sort the coding rules according to levels and generate a proper coding rule, thereby allowing the sound wave communication to be established effectively.

The sound wave communication standard is set S1201. The mobile terminal or the incoming call notifying apparatus, which participate in the communication according to the set sound communication standard, generates a corresponding coding rule so as to send the generated coding rule to a relative incoming call notifying apparatus or the mobile terminal S1202. The sound wave communication is established according to the rules by loading the generated or sent coding rule on the respective apparatus S1203. Of course, the step S1201 can be omitted without defining the sound wave communication standard and one or more apparatuses participating in the communication can generate and send the coding rule. Each apparatus establishes the sound wave communication by the generated and sent coding rule.

According to another embodiment of the present invention, the mobile terminal or the incoming call notifying apparatus does not send after generating the coding rule, so as to establish the sound wave communication according to the coding rule generated by each apparatus. According to still another embodiment of the present invention, one or more apparatus that particulates in the communication send after generating the communication rule according to the set communication standard and establishes the sound wave communication according to the generated and sent coding rule.

More particularly, in the step 1201, the sound wave communication standard is determined considering 4 factors that have an affect on the coding rule determination and the sound wave communication standard. One of the mobile terminal and incoming call notifying apparatus determines the sound wave communication standard and notifies a relative apparatus. The sound wave communication standard is set by recommendation, negotiation, decision processes.

In the recommendation process, the mobile terminal or the user sets automatically or manually a recommendation priority of the sound wave communication standard and recommends the set priority to the incoming call notifying apparatus. The sound wave communication standard is negotiated and decided according to the recommendation priority. The negotiation can be automatically performed by pre-set default sound wave communication. In the recommendation process, the mobile terminal or incoming call notifying apparatus automatically or manually selects considering the user's requests, the surrounding situation, and its performance, and recommends one or more communication standard together with the priority.

In the negotiation, among the sound wave communication standards recommended by one of the mobile terminal and the incoming call notifying apparatus, the relative apparatus chooses the communication standard considering the 4 factors and then may be decided by the negotiation. For example, if the performance of the relative apparatus is satisfied with third priority and not first and second priorities, the communication standard of the third priority is decided. Additionally, each apparatus, which participates in the communication, recommends the sound wave communication standards having the priority, compares and negotiates with them, and then decides the sound communication standard. The negotiation is performed by the default sound wave communication, the near-field communication or by inputting directly according to the user's determination.

According to another embodiment, the sound communication standard of two communication apparatuses is different from each other. When “A” and “B” apparatuses perform the sound wave communication, if the performance of the apparatuses is allowed, the communication from the “A” apparatus to the “B” apparatus is performed by a random standard “g”, and the communication from the “B” to the “A” is performed by a standard “h”.

In the step S1201, if the standard of the sound wave communication is established, the coding rule is generated and sent in the step S1202. If a concept of the sound wave communication is not defined or is communicated by one sound wave communication standard, the step S120 is started. Various coding rules exit in one sound wave communication standard. Among them, a coding rule at present time is generated.

For example, considering calmness, low power, interference prevention and security, if the sound wave communication standard is decided by a transmission speed of a middle level, the interference prevention of the middle level, and a low volume level, various coding rules conforming to the levels can be allowed. One of allowable mapping tables is decided, and a coding rule of generation information, variable information, a sound wave unit time, and a data frame structure for the mapping table is decided. If necessary, a coding rule is generated by deciding time synchronization information for synchronizing a data sending/receiving time, a same tone continuation evasion rule for preventing same tone from being continuously sent, and a cipher rule. The coding rule is automatically or manually decided.

According to one embodiment, each apparatus does not generate and send the coding rule according to the sound wave communication standard. According to another embodiment, the generated coding rule can be sent. When the coding rule is sent, the mapping table can be sent, and the relative apparatus can also send mapping table generation information, index information and mapping table variable information in holding previously a logic related to the mapping table generation or the mapping table.

According to one embodiment, even when the coding rule is sent, the negotiation for the coding rule can be progressed. If the concept for the sound wave communication standard is not defined or the communication is established by one sound wave communication standard, the coding rule is sent and the negotiation for the sent coding rule can be progressed like the sound wave communication standard of the step S1201.

The generated or sent coding rule is loaded on each apparatus so as to establish the sound wave communication according to the rule S1203. If the sound wave communication is established, the incoming call notifying function is operated S1204.

FIG. 13 is a diagram illustrating constituents for a menu of the sound wave communication standard.

A selection menu for setting manually the sound wave communication standard can be constituted of various shapes. FIG. 13 shows the calmness level of the communication and a data reliability level. In this time, a user selects menu items in stages.

The calmness level of the communication is indicated to Silent (S), Gentle (G), Usual (U), and Powerful (P). The user selects one of them. The calmness communication is not always a small volume. A frequency sound of an ultrasonic wave band is used for the data transmission, or a proper sound wave is produced according to the surrounding sound situation.

If the “G” level is selected from the “S” level, a selection menu of a data reliability level in the communication is displayed. The data reliability is displayed by dividing into Excellent (E), High (H), and M (Medium) so as to enable the user to select them. If the reliability is high, various interference prevention technologies are used and a data transmission error is severely checked.

If the “H” level in the reliability level is selected, the level capable of carrying out the apparatus's performance is displayed. In FIG. 13, the levels GH3, GH4 and GH5 are displayed. If the user selects the displayed level, some levels from the first priority are recommended. Even when the first priority is only selected, the level is recommended by deciding automatically the priority according to an already set priority. The level recommended with the priority is decided by the negotiation.

In the negotiation, among the sound wave standards recommended by one apparatus, the relative apparatus selects and decides a proper level considering the 4 factors. If the proper level is not existed, the other level is again recommended. Through the process, the negotiation is decided. As another example, each apparatus participating in the communication recommends the sound wave communication standard having the priority, compares and negotiates the standard, and decides. If the negotiated level is not existed, the other level is again recommended. The negotiation is performed by the default sound wave communication between the apparatuses, and the other near-field communication, or directly inputs each apparatus according to the user's determination.

If the user does not manually set the sound wave communication standard, the standard is automatically set. Many part of the manual set is also automatically set except a process of enabling the user to select the menu. The automatic set is set previously or according to the changeable priority. The priority is set in order of cost, calmness, power consumption, interference prevention, security and communication speed.

In the automatic set, the negotiation is performed by the default sound wave communication, the other near-field communication. In the default sound wave communication, almost all of sound wave communication apparatus tries to establish unconditionally a low level of default sound wave communication so as to communicate with the relative apparatus, and then set automatically the sound wave communication standard. In the level negotiation between two sound wave communication apparatuses, two apparatuses adjusts the communication standard by automatic compromise of two apparatuses, when one apparatus gives the priority for the one apparatus's level.

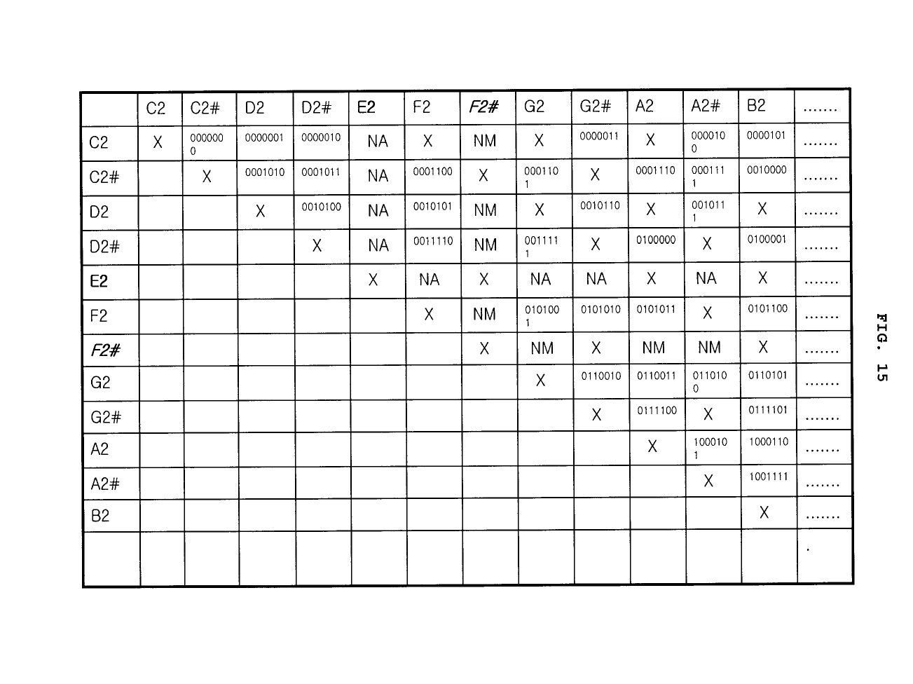

FIG. 14 is a diagram illustrating an example for a data packet frame of the near-sound-wave communication.

The data packet frame includes Preamble for synchronization, a star of frame delimiter (SFD), frame length (FL), a destination address or ID, an outgoing call address or ID, and a frame check sequence (FCS). In FIG. 14, the data packet format is systematically constituted according to a protocol class.

According to one embodiment, a slander establishes the encoding communication to exclude from sending the inference signal. The encoding rule is a part of the coding rule. If the slander produces the interference signal disguised to the user unit's address/ID, the user unit having the address/ID receives the interference signal and then informs the relative unit that the interference signal is not sent by itself. As another example, if the slander finds out the user's address/ID and the coding rule to send the interference signal, the interference signal is decoded, and if the production of the interference signal is not solved, it determines whether to be the interference signal or an effective signal.

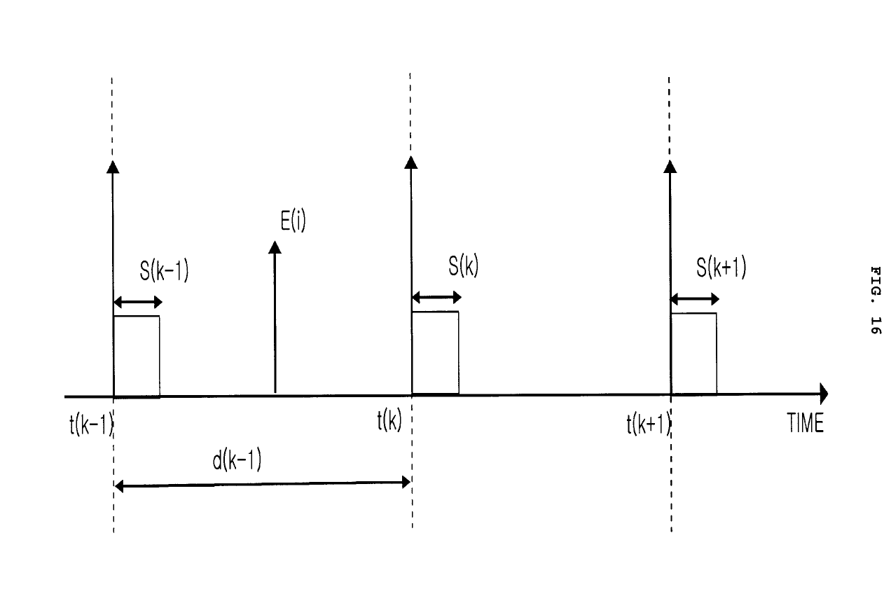

FIG. 15 shows a mapping rule using combination of two frequency sounds and a method of applying a disallowable frequency sound and a meaningless frequency sound, where the disallowable frequency sound is E2 sound and the meaningless frequency sound is F2# sound.

A concept of disallowable frequency sound and meaningless frequency sound is not only applied to the mapping table using the MFSK of FIG. 15, but the same as also similarly using the BFSK, PSK, ASK, QAM, and others.

The sound wave communication is required to resist against the surrounding noise or intensive interference sound wave. The intensive slander is divided into an obstructer generating disturbance sound wave and a spy extracting information by overhearing. To prevent interference and security, the data frequency sound or the allowable frequency sound is a frequency sound (sound height) meaning real data. The disallowable frequency sound is a frequency except from the data transmission of the present coding rule, and the corresponding sound communication apparatus does not produce the sound wave of the frequency. If the sound near to the disallowable frequency is received, it means that the noise or the slander exits. The meaningless frequency sound is a frequency excluded from the data transmission of the present coding rule and confuses the spy by generating the sound wave of meaningless frequency sound intentionally. The data frequency sound, disallowable frequency sound and meaningless frequency sound are defined as a usable frequency sound. There is no need to select only the frequency sound of the sound height as the usable frequency sound. In the BFSK, by selecting frequency sounds f1 and f2 as the data frequency sound and a frequency sound f3 as the meaningless frequency sound, the sound wave of the three frequency sounds is produced. According to one embodiment, the mapping table is constituted of the data frequency sound, disallowable frequency sound and meaningless frequency sound. How to arrange disallowable frequency sound and meaningless frequency sound in the data frequency sound can be decided by information that generates and varies the mapping table.

In FIG. 15, the data frequency sound, disallowable frequency sound and meaningless frequency sound are shown. It is shown that “E2” sound is the disallowable frequency sound, “F2#” sound is the meaningless frequency sound, and a remaining sound is the data frequency sound. The mapping table is constituted between the digital data and the sound wave by the combination of two frequency sounds. The combination except overtone indicates “X”. If the disallowable frequency sound is included in the combination, “NA” is indicated. If the meaningless frequency sound is included in the combination, “NM” is indicated. Based on the mapping table, the data is sent as the sound wave, the spy is confused by the meaningless frequency sound, and whether there is the obstructer is investigated.

According to one embodiment, by varying the mapping table, the sound wave communication system is constructed to resist against the interference and assure security. Varying the mapping table includes varying the data frequency sound, the disallowable frequency sound or meaningless frequency sound. The mapping table is varied by information written in information for generating and varying the mapping table. When using the BFSK of FIG. 9a, the frequencies f1 and f2 are varied by time so as to vary the mapping table. Varying an amplitude and phase is included except varying the frequency of the sound wave. The varying can be varied according to the time. If the mapping table is varied according to the time or order, the data having each different mapping table is encoded and decoded in a specific time or order. In the specific time or the order, the obstructer or spy who does not know exactly the mapping table is hard to disturb the sound wave communication and decode the data during the sound wave communication.

According to one embodiment, to resist the transmission against the interference and prevent the transmission error, the same frequency sound avoid rule is generated so as not to receive continuously the same sound height, and is included in the coding rule generation. For example, if the same sound height is continuously sent during above the preset time, other frequency that is not meant as the data is inserted.

To be distinguished from the surrounding sound wave communication, the sending volume of each sound wave communication apparatus is limited. Each participation apparatus reads as the signal the strength of the sound wave within the accepted volume range.

According to one embodiment, when the sound wave is sent, by receiving the surrounding sound wave before sending or by feedback, it detects if there is the severe noise or the disturbing sound wave in sending the signal of the sound wave.

FIG. 16 shows a timing explaining sending/receiving timing synchronization for a low power sound wave communication.

In the case where the sound wave communication participation apparatus has received the surrounding sound wave, if the surrounding sound wave is the disturbance sound wave or severe noise, it waits for the sending. According another example, by feedback of the sound wave at a time of the sending, it determines which degree the disturbance sound and/or interference sound are included. As a result of the determination, it is decided whether the data is again sent. The transmission apparatus additionally includes determining and adjusting whether the volume of the speaker and microphone is proper. If the severe disturbance sound that can be not solved by the volume adjustment exists, the mapping table is varied by processing a sound adjacent to the frequency sound of the disturbance sound wave as disallowable or meaningless frequency sound. As a result, the transmission apparatus communicates using the sound wave of the frequency region except the noise/disturbance frequency.

As people can hear the sound, the user can feel the noise and interference sound wave. As one example, if the interference sound wave is continued, the user determines the communication using other frequency sound and amends the interference sound wave by variable mapping table in a user interface. As another example, the coding rule includes information on a tone, a phonetic sign, etc. If an outgoing frequency sound is sent to put the tone and phonetic information such as “Ah”, “Oh”, “Ra”, and others, the receiving unit recognizes only frequency, but the user can recognize the tone and phonetic information. Accordingly, even when the interference sound of the same frequency sound is produced in neighboring area, the user can recognize the interference due to the difference of the tone and phonetic information.

On the other hand, the sound wave communication is required to minimize that it would bother people in the adjacent area. For example, when the mapping table is selected and the sound wave is sent, one's favorite tone is used. Additionally, when the tone is used, it is added by using chiefly meaningless frequency sound except real data, One's favorite melody/tone is sent. Or, by performing the sound wave communication while producing basically a while noise, people can hear the white noise without bothering people in the adjacent area. Or, by producing a sound wave that can feel comfortable and delightful, by communicating using natural sound, or by using the ultrasonic wave and a frequency sound of a band adjacent to the ultrasonic wave as data frequency sound and meaningless frequency sound, the calm communication is performed.

The sound wave communication should be continued during the incoming call notifying operation. If the sound wave communication engine is continually operated, the load of CPU and the consumption of the battery power are increased. Because the sound wave receiver cannot recognize whether or not the transmission has occurred even if the transmitter does not send the sound wave signal, the process like detecting the frequency of the sound wave should be continued by detecting the sound wave. According to the one exemplary embodiment of the present invention, there is provided a sending/receiving time synchronization method. The sending/receiving time synchronization rule is sent as a part of the coding rule at the time of sending the coding rule. The communication apparatuses sharing the sending/receiving time synchronization rule communicates each other as shown in FIG. 16. Referring to FIG. 16, t(k−1), t(k), t(k+1) respectively means a sending/receiving start time, and d(k−1), d(k) respectively means a starting time, and S(k−1), S(k), S(k+1) respectively means a sending/receiving operation time. The communication apparatuses are synchronized of time each other. The time synchronization can be performed by using a timer. The communication apparatus sends/receives only from the predetermined sending/receiving time t(k) to S(k), and does not send/receive during remaining time to reduce consumption of source and power. The communication apparatus should send a signal after waiting until at least next sending/receiving starting time t(k) even if a sending request is generated at the time of E(i).

As describe above, there is described for the request that is requested when the sound wave communication is performed between the portable terminal and the incoming call notifying apparatus by applying data communication using sound wave. However, because an amount of data or a request of security is not severe in the incoming call notifying service, there is no problem although the data communication method like above is not applied.

That is, the incoming call notifying service can be realized by a simple construction in which recognizes the sound wave having a certain frequency band of a specific pattern sent from the portable terminal at time of incoming signal and includes an electronic circuit (including an analog or digital circuit) capable of driving a motor, a light emitter and a speaker, and such construction is also included in the scope of the technical idea of the present invention.

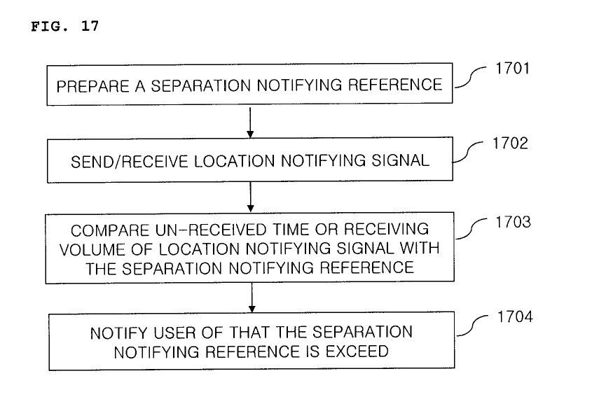

FIG. 17 is a flow chart illustrating a method of notifying the user of the mobile terminal's separation and preventing the mobile terminal from being lost.

According to the one exemplary embodiment of the present invention, there is provided a separation notifying and loss preventing method by using the sound wave communication incoming call notifying apparatus in addition to the incoming call notifying function. For the separation notifying, a pair of a portable terminal and a incoming call notifying apparatus coupled each other sends/receives a location notifying signal in addition to the incoming call notifying signal. For example, the portable terminal periodically sends the location notifying signal to the incoming call notifying apparatus in a predetermined interval (for example, per 5 seconds), and the incoming call notifying apparatus determines that the two apparatuses are dislocated far each other more than a predetermined distance if the location notifying signal is not received in the predetermined interval or the sound level of the location notifying signal is lower than predetermined level, and notifies the user of a loss or separation. The separation notifying may be notified to the user by the portable terminal or the incoming call notifying apparatus, or both of them, through sound, vibration, light emitting and the like. For another example, the location notifying signal is sent through the speaker of the incoming call notifying apparatus and the portable terminal receives the location notifying signal.

In the embodiment of the present invention, the sending time of the location notifying signal is synchronized to the sending/receiving operation time for the incoming call notifying shown in FIG. 16. That is, the incoming call notifying signal or the location notifying signal is selectively sent/received only during the synchronized operation time so as to minimize the consumption of electrical power.

In the step S1701, a separation notifying criteria is established, and the separation notifying criteria is a predetermined time that the location notifying signal has not been received or the sound level of the received location notifying signal. The separation notifying criteria is inputted or sent to each apparatus. Next, the coupled pair of the portable terminal and the incoming call notifying apparatus sends and receives the location notifying signal S1702. Next, it is decided whether the time that the location notifying signal has not been received exceeds the separation notifying standard, or whether the sound level of the received location notifying signal is so low to exceed the separation notifying standard S1703. If so, the user is notified through sound, vibration, light emitting and the like S1704. The steps S1701 to S1704 may be performed in the portable terminal or the incoming call notifying apparatus.

As described above, the incoming call notifying apparatus according to the present invention produces the following effects.

First, the incoming call notifying function using the incoming call notifying apparatus can be realized by downloading software in almost all commercial portable terminals without changing the portable terminal or adding an additional transmitter.

Second, the incoming call notifying can be performed by lower power communication than RF communication like Bluetooth by using the sound wave communication.

Third, because the sound wave communication needs no additional space, it is preferable for a compact and low-cost portable terminal.

Fourth, the loss of the portable terminal can be prevented by notifying the user of that the portable terminal is dislocated from the incoming call notifying apparatus more than the predetermined distance by using the incoming call notifying apparatus.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. An incoming call notifying system for notifying a user of an incoming call of a mobile terminal, comprising:
a mobile terminal including a first speaker configured to output a sound wave and a controller configured to control so as to output a sound wave signal of a predetermined frequency to the speaker in the incoming call; and
an incoming call notifying apparatus including a microphone configured to receive a surrounding sound wave, a processor configured to analyze the sound wave received from the microphone, determine whether the received sound wave is the sound wave signal sent from the speaker of the mobile terminal, and if so, send a command to a notifying means.

2. The system of claim 1, wherein the sound wave signal from the mobile terminal includes: caller identification information of a predetermined group such as families, friends, and colleagues; caller identification information of a predetermined specific people; and identification information on kinds or contents of incoming messages received from the mobile terminal.

3. The system of claim 2, wherein the incoming call notifying apparatus receives the identification information on the group, the specific peoples and the kinds or contents of messages received in the mobile terminal, and operates the notifying means using each differently predetermined pattern according to the identification information.

4. The system of claim 1, wherein the sound wave signal from the mobile terminal include various notifying pattern according to caller identification information on the predetermined group such as families, friends, and colleagues, the predetermined specific people, and kinds or contents of messages received from the mobile terminal.

5. The system of claim 4, wherein the incoming call notifying apparatus operates the notifying means according to the pattern of the sound wave signal from the mobile terminal.

6. The system of claim 1, wherein the notifying means includes a motor, a display and a speaker.

7. The system of claim 1, wherein the predetermined frequency is more than 15 kHz.

8. The system of claim 1, wherein the controller comprises a mapping table between the sound wave and data, and converts sending data to a sound wave corresponding to the sending data based on the mapping table.

9. The system of claim 1, wherein the processor comprises a mapping table between the sound wave and data, and determines whether the received sound wave is sent from the mobile terminal based on the mapping table.

10. The system of claim 9, wherein the processor receives the sound wave sent from the mobile terminal so as to determine the sent data, and instructs a command to drive the motor according to the data.

11. The system of claim 1, wherein the first speaker periodically or continuously sends the predetermined sound wave signal as a predetermined time interval, and the processor of the incoming call notifying apparatus generates an alarm signal when the predetermined sound wave signal is not received at the predetermined time interval or when the strength of the sound wave signal is less than a predetermined level.

12. The system of claim 11, wherein the incoming call notifying apparatus further comprises a second speaker, and processes the alarm signal as an alarm sound produced from the second speaker.

13. The system of claim 1, wherein the incoming call notifying apparatus further comprises the second speaker, and periodically or continuously outputs a predetermined sound wave signal through at the predetermined time interval, and wherein the mobile terminal generates an alarm signal when the predetermined sound wave signal is not received the predetermined time interval or when the strength of the sound wave signal is less than a predetermined level.

14. A method for notifying a user of an incoming call of a mobile terminal using an incoming call notifying apparatus separated from the mobile terminal, comprising:
(a) the mobile terminal receiving the incoming call from a base station;
(b) the mobile terminal outputting a sound wave signal of a predetermined frequency band through a built-in speaker, when the incoming call is received;
(c) the incoming call notifying apparatus receiving the sound wave signal from the mobile terminal among the received sound waves; and
(d) the incoming call notifying apparatus notifying a user of the incoming call of the mobile terminal through a notifying means, when the sound wave signal is received.

15. The method of claim 14, wherein the step (b) comprises:
preparing sound wave signal according to a predetermined caller group such as families, friends and colleagues, predetermined caller, and kinds and contents of messages received in the mobile terminal; and
outputting the prepared different sound wave signal.

16. The method of claim 14, further comprising:
the mobile terminal outputting periodically or continuously a predetermined signal through the speaker; and
the incoming call notifying apparatus generating an alarm signal when the predetermined signal is not received at the predetermined time interval or when the strength of the sound wave signal is less than a predetermined level.

17. The method of claim 14, further comprising:
the mobile terminal outputting periodically or continuously a predetermined signal through the speaker; and
the mobile terminal generating an alarm signal when the predetermined signal is not received at the predetermined time interval or when the strength of the sound wave signal is less than a predetermined level.
